(19) United States
(12) Patent Application Publication
(10) Pub. No.: US 2026/0025712 A1
(43) Pub. Date: Jan. 22, 2026

(54) METHODS FOR SERVICE CACHING AND TASK MIGRATIONS BASED ON INTERNET OF VEHICLES

(71) Applicant: CHONGQING UNIVERSITY OF POSTS AND TELECOMMUNICATIONS, Chongqing (CN)

(72) Inventors: Yun LI, Chongqing (CN); Bingyi CHEN, Chongqing (CN); Linli ZUO, Chongqing (CN); Shichao XIA, Chongqing (CN); Guangfu WU, Chongqing (CN)

(73) Assignee: CHONGQING UNIVERSITY OF POSTS AND TELECOMMUNICATIONS, Chongqing (CN)

(21) Appl. No.: 19/341,008

(22) Filed: Sep. 26, 2025

Related U.S. Application Data
(63) Continuation-in-part of application No. PCT/CN2025/090182, filed on Apr. 21, 2025.

(30) Foreign Application Priority Data
May 16, 2024 (CN) 202410608883.8

(51) Int. Cl. H04W 28/14; G06N 7/01; H04W 4/40; H04W 28/06; H04W 36/00

(52) U.S. Cl. CPC H04W 28/14; G06N 7/01; H04W 4/40; H04W 28/06; H04W 36/0007

(57) ABSTRACT

A method for service caching and task migration based on Internet of Vehicles (IoV) is provided. The method includes: establishing a system model based on the Internet of Vehicles, and constructing a service caching model and a task migration model based on the system model, constructing a joint optimization problem for service caching and task migration based on the service caching model and the task migration model, abstracting the joint optimization problem into a Markov decision process; and determining an optimal caching decision and an optimal migration decision by solving the joint optimization problem of service caching and task migration using a multi-intelligence body reinforcement learning method based on the Markov decision process. By jointly optimizing service caching and task migration, the present disclosure further reduces the latency and energy consumption in the service caching process and the cost of task migration, and improves the service quality of the system.

### CROSS-REFERENCE TO RELATED APPLICATIONS

This application is a continuation-in-part application of International Application No. PCT/CN2025/090182 filed Apr. 21, 2025, which claims priority of Chinese patent Application No. 202410608883.8 filed on May 16, 2024, the entire contents of each of which are incorporated herein by reference.

### TECHNICAL FIELD

The present disclosure generally relates to the field of mobile communication technology, and in particular, to a method for service caching and task migration based on the Internet of Vehicles (IoV).

### BACKGROUND

In recent years, Internet of Vehicles (IoV) has gradually realized information interaction and sharing between vehicle and vehicle, vehicle and road, and vehicle and network, etc. The vehicle can realize services including emergency response, entertainment, road information, network, storage, traffic safety, etc., through an on-board unit (OBU). However, due to the lack of sufficient computational resources and energy supply in a vehicle's OBU, a large count of latency-sensitive and computation-intensive tasks generated by the vehicle during movement are difficult to handle locally. Mobile cloud computing, as a computing paradigm in the field of mobile applications, allows mobile devices to utilize cloud resources to complete computation-intensive tasks, thereby improving performance and saving energy. By migrating computational tasks to cloud servers for processing, vehicles effectively address the issues of insufficient computational resources and energy. Additionally, cloud servers provide substantial storage space, enabling vehicle users to upload data and access it in real time, thereby reducing the storage pressure on vehicles. However, due to the relatively long distance between cloud servers and mobile devices, the process of transmitting data can result in significant latency. Moreover, when the count of edge devices grows exponentially, transmission links are prone to congestion. In the Internet of Vehicles (IoV), numerous real-time applications (e.g., autonomous driving APPs, AR navigation APPs, etc.) generate latency-sensitive computational tasks that require extremely low transmission latency, and mobile cloud computing is clearly insufficient to support the delivery of large-scale content while meeting the low-latency requirements of vehicular networks.

To address the shortcomings of mobile cloud computing, mobile edge computing (MEC) has emerged. In the IoV, base stations (BS) with certain computational resources serve as edge servers to execute tasks requested by vehicles at the network edge. Vehicles can communicate with edge nodes via roadside units (RSU) to reduce response latency and energy consumption, meeting the increasingly stringent system performance demands posed by unprecedented explosive data traffic and vehicle applications. Furthermore, vehicles themselves can be regarded as edge nodes. If a vehicle possesses idle computing resources, these resources can be utilized to process computational tasks, thereby improving resource utilization, alleviating network congestion, and addressing the issue of edge servers being less resource-rich compared to cloud servers.

However, in the IoV, multiple vehicles often require access to similar services or data, such as road condition information. If tasks are processed solely by relying on the powerful computing and storage capabilities of the cloud, the long distance between the cloud and vehicle users can lead to excessive load on the backhaul links, thereby degrading system performance. Additionally, due to the highly dynamic network topology, communication between vehicles and roadside units (RSUs) may be affected by frequently changing environmental conditions, and the availability and quality of edge resources can constantly fluctuate.

### SUMMARY

One or more embodiments of the present disclosure provide a method for service caching and task migration based on the IoV, comprising: S1, establishing a system model based on the Internet of Vehicles, and constructing a service caching model and a task migration model based on the system model, wherein the system model includes a device layer, an edge layer, and a cloud layer, the device layer includes a vehicle user (UV) and a roadside unit (RSU), the edge layer includes a base station (BS) and an MEC server of the BS, the BS corresponds to a plurality of RSUs, the cloud layer includes a supplier, the RSU is configured to receive a service request from the UV and send the service request to the BS corresponding to the edge layer, and the MEC server of the BS is configured to cache a service provided by the supplier of the cloud layer and provide the service to the UV via the corresponding RSU; S2, constructing a joint optimization problem for service caching and task migration based on the service caching model and the task migration model, wherein the constructing the task migration model includes: representing a maximum data amount transmittable to a vehicle v within a coverage of an RSU m as D_{m,v}^{max}, wherein sₖ denotes a size of a vehicle request service k, sₖ>D_{m,v}^{max} indicates that a task migration occurs, and sₖ≤D_{m,v}^{max} indicates that the task migration does not occur; representing an RSU migration decision as W_{v,k}(t)∈{0,1,2,3 . . . }, which denotes a count of RSU migrations during a process of the vehicle v requesting the vehicle request service k, representing a BS migration decision as mig_{v,n}(t)∈{0,1}, wherein mig_{v,n}(t)=1 indicates that the vehicle v drives away from a coverage of a current BS, and mig_{v,n}(t)=0 indicates that the vehicle v does not drive away from the coverage of the current BS; and calculating a total migration cost Cₐₗₗ^{mig}(t) for the vehicle request service k based on the RSU migration decision and the BS migration decision, wherein K denotes a count of vehicle request services, V denotes a count of vehicles, N denotes a count of all MEC servers, and sₖ denotes a size of the vehicle request service k; S3. abstracting the joint optimization problem into a Markov decision process; and S4, determining an optimal caching decision and an optimal migration decision by solving the joint optimization problem of service caching and task migration using a multi-intelligence body reinforcement learning method based on the Markov decision process.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a structural diagram of a system model based on Internet of Vehicles according to some embodiments of the present disclosure;

FIG. 2 is an exemplary flowchart of a method for service caching and task migration based on Internet of Vehicles according to some embodiments of the present disclosure; and

FIG. 3 is a framework diagram of a multi-intelligence body reinforcement learning method (MADDPG algorithm) according to some embodiments of the present disclosure.

### DETAILED DESCRIPTION

To illustrate the technical solutions of the embodiments of this specification more clearly, the following provides a brief introduction to the drawings required for describing the embodiments. Obviously, the drawings in the following description are merely some examples or embodiments of this specification. For those of ordinary skill in the art, without creative effort, this specification may be applied to other similar scenarios based on these drawings. Unless otherwise indicated by the context or otherwise stated, the same reference numerals in the drawings represent the same structures or operations.

It should be understood that the terms “system,” “device,” “unit,” and/or “module” used herein are methods for distinguishing different components, elements, parts, sections, or assemblies at different levels. However, if other words can achieve the same purpose, these terms may be replaced by other expressions.

As used in this specification and the claims, unless the context clearly indicates an exception, the terms “a,” “an,” “one,” and/or “the” are not intended to specifically denote the singular form and may also include the plural form. Generally, the terms “comprise” and “include” merely indicate the inclusion of clearly identified steps and elements, and these steps and elements do not constitute an exhaustive list. Methods or devices may also include other steps or elements.

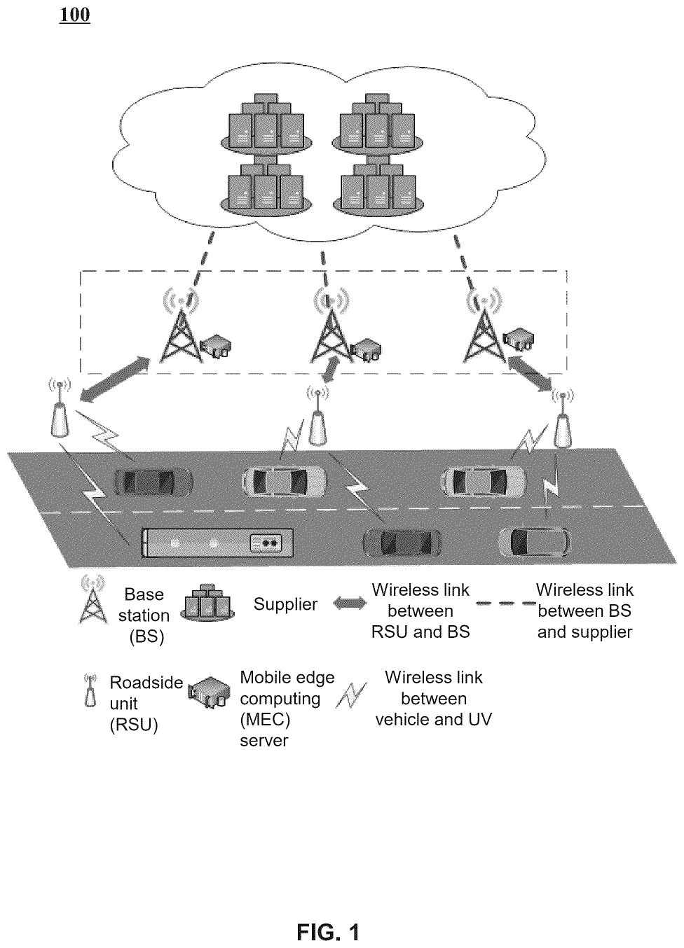

FIG. 1 is a structural diagram of a system model based on Internet of Vehicles according to some embodiments of the present disclosure.

In some embodiments, the system model may include a device layer, an edge layer, and a cloud layer.

The system model is a processing model suitable for regulating the interaction relationship and data flow logic of a plurality of entities (vehicles, infrastructures, clouds, etc.) in the IoV environment. A core role of the system model is to clarify the functional boundaries and collaboration mechanisms of all participating parties through a hierarchical architecture, providing an overall framework for the design of key technologies, such as service caching, task migration, and resource allocation. The system model serves as the foundation for achieving efficient services in the IoV.

The device layer is a data collection layer of the IoV. The device layer contains vehicle users (UVs) and road side units (RSUs).

The UV is a vehicle that the user is driving. The UV may include an input device such as a touch screen, a microphone, etc., for receiving a service instruction from the user. The UV may collect driving logs containing real-time vehicle location, speed, and other information through sensors distributed on the vehicle body.

In some embodiments, the UV further includes an on-board unit (OBU). The OBU refers to an integrated communication terminal installed inside the vehicle and capable of realizing the communication of the IoV.

The RSU is a communication device deployed on both sides of a road. The RSUs may be evenly distributed along the road, thereby ensuring that the UV is always within a coverage of the RSU.

In some embodiments, the RSU may also include a plurality of types of sensors to capture roadside information such as ambient weather, real-time road conditions, or the like.

The RSU receives a service request from the UV via a wireless channel, and sends the service request to the BS at the edge layer for processing.

In some embodiments, a set of RSUs may be defined as m∈{1, 2 . . . , M} and a set of UVs may be defined as v∈{1, 2 . . . , V}.

The edge layer is a localized processing core of the IoV, and the edge layer consists of a BS and a corresponding MEC server. In some embodiments, the edge layer consists of the BS and a mobile edge computing (MEC) server equipped by the BS. The BS may correspond to one or more RSUs, e.g., the RSUs within a signal coverage of the BS may be identified as the RSUs corresponding to the BS.

The MEC server is a server used for edge computing, and the MEC server may “sink” a cloud service to the network edge to satisfy the stringent requirements of low latency of the IoV, avoiding the problem of high latency caused by long-distance transmission from the cloud.

In some embodiments, the MEC server is used to cache a service program provided by a supplier and provide the service program to the UV, and a set of the MEC server is n∈{1, 2 . . . , N}.

The cloud layer is a cloud service platform of the IoV, the cloud layer provides many types of services to the vehicle, and the cloud layer includes supplier. In some embodiments, the cloud layer is composed of the supplier.

The supplier is a service provider in the IoV. The suppliers may include traffic information service providers, media entertainment providers, public management service providers, etc. The providers may provide automated driving decisions, navigation and location, multimedia entertainment, traffic control information, real-time road condition updates, and other services to vehicles.

In some embodiments, the BS is distributed below the cloud layer, and the supplier and the BS is connected to each other via a wireless link.

The RSU is used to receive a service request from the UV and send the received service request to a corresponding BS in the edge layer. The MEC server of the BS is used to cache a service provided by the supplier in the cloud layer and provide the service to the UV via a corresponding RSU.

Taking the provision of an autonomous driving service to a vehicle user as an example, a passenger can issue an autonomous driving instruction to the UV. The UV uploads an autonomous driving request to an RSU via a wireless channel, and the RSU forwards the autonomous driving request to the BS. The BS then uploads the autonomous driving request to the cloud layer. The cloud layer determines a supplier of autonomous driving and an autonomous driving service of the supplier. The cloud layer issues a caching instruction to the MEC server, instructing the MEC server to cache relevant data for the autonomous driving service. Once caching is complete, the MEC server can provide a low-latency autonomous driving service to the vehicle based on driving logs and roadside information uploaded by the RSU and the vehicle.

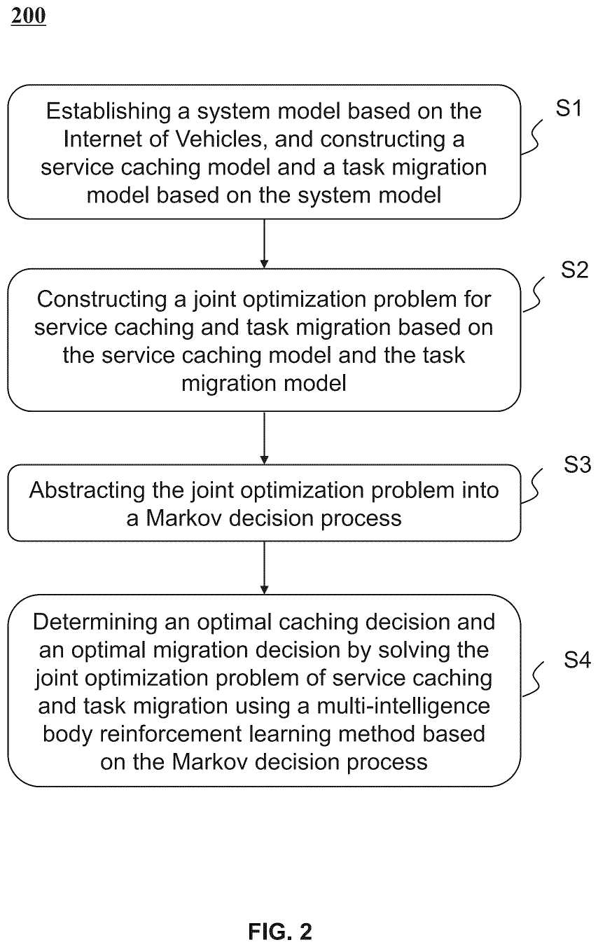

FIG. 2 is an exemplary flowchart of a method for service caching and task migration based on Internet of Vehicles according to some embodiments of the present disclosure. As shown in FIG. 2, the described method includes operations S1 to S4. In some embodiments, operations S1 to S4 may be performed by an MEC server at the edge layer, or be performed by a cloud server located at the cloud layer, or be performed by the MEC server and the cloud server in concert.

In S1, a system model is established based on the IoV, and a service caching model and a task migration model are constructed based on the system model.

The system model is used to simulate and model actual business scenarios such as service requests, transmission, caching, and migration during vehicle movement.

In some embodiments, the construction of the system model includes: a vehicle is deployed on a horizontal road, and RSUs are evenly distributed on one side of the road with a coverage radius of L₁, and the BS has a coverage radius of L₂; the vehicle request a required service from an RSU via the wireless channel, and the RSU forwards the request to the BS; if the MEC server has cached the corresponding service, the MEC server transmits data of the service back to the vehicle through the RSU; otherwise, the MEC server requests a service program from the supplier at the cloud layer.

Due to the high-speed movement of the vehicle, the RSU communicating with the vehicle may also change, and the transmission tasks may be migrated from one RSU (the old RSU) to another RSU (the new RSU). During the vehicle movement, as the old RSU disconnects from the vehicle, the cached service program becomes invalid, and the new RSU needs to cache the service program again, the frequent switching of connections between the vehicle and the RSUs leads to additional data transmission overhead and computational resource consumption. Consequently, both the RSUs and the MEC server need to allocate a portion of their computational resources to handle service caching and task migration requests.

In some embodiments, the cloud server may also build a vehicle mobility model and a communication model based on the system model.

The vehicle mobility model is a mathematical model for describing the laws of dynamic change of the vehicle location in a road network over time. By quantifying the motion state of the vehicle (e.g., location, speed, and other parameters), it provides basic data support for scenarios such as communication interaction between the vehicle and the RSU, trajectory prediction, and resource allocation.

In some embodiments, the construction of the vehicle mobility model includes: establishing a coordinate axis with a horizontal axis parallel to the road, dividing time into many equally spaced time slot t, t∈{1,2,3 . . . , T}, a duration of the time slot t may be preset based on a priori experience, (xᵥ(t),yᵥ(t)) denotes a location of the vehicle v on the coordinate axis during the time slot t, (xₘ,yₘ) denotes a location of an RSU m, and the location of the RSU m is kept unchanged. The vehicle's speed is aᵥ, which obeys a uniform distribution, then the location [xᵥ(t), yᵥ(t)] of the vehicle during the time slot t may be expressed as:

$${x}_{v} ( t ) = {x}_{v} ( 0 ) + {a}_{v} t , \qquad ( 1 )$$

$${y}_{v} ( t ) = {y}_{v} ( 0 ) , \qquad ( 2 )$$

where (xᵥ(0), yᵥ(0)) denotes an initial location of the vehicle v.

Thus, a distance between the vehicle v and the RSU m during the time slot t may be expressed as:

$${d}_{v , m} ( t ) = \sqrt{{[ {x}_{v} ( t ) - {x}_{m} ]}^{2} + {[ {y}_{v} ( t ) - {y}_{m} ]}^{2}} . \qquad ( 3 )$$

The vehicle establishes a communication link with the nearest RSU, and the distance may be expressed as:

$${d}_{v}^{min} ( t ) = {min}_{m ∈ M} \{ {d}_{v , m} ( t ) \} . \qquad ( 4 )$$

The communication model is a mathematical model that describes a process of data transmission between the UV and the RSU, a process of data transmission between the UV and the BS, and the key parameters in the IoV. The core role of the communication model is to quantify performance metrics (e.g., transmission rate, energy consumption, signal quality, etc.) of a communication link, which provides a theoretical basis for analyzing the feasibility of service transmission, optimizing the task migration strategy, and evaluating the energy efficiency of the system.

In some embodiments, the vehicle communicates with the BS equipped with the MEC server through the RSU. Since the transmission rate between the RSU and the BS is very high and the transmission energy consumption generated between them is relatively small, the present disclosure only considers the transmission process from the vehicle to the RSU. Thus, during the time slot t, the vehicle communicates with only one RSU at a time.

In some embodiments, the construction of the communication model includes the following operations.

A signal-to-noise ratio SNR_{v,m}(t) between the vehicle v and the RSU m during the time slot t is expressed by the following formula:

$$S N {R}_{v , m} ( t ) = \frac{{p}_{v , m} ( t ) {h}_{v , m} ( t )}{{σ}^{2} {δ}_{v , m} {d}_{v , m} ( t )} , \qquad ( 5 )$$

where p_{v,m}(t) denotes a transmission power between the vehicle v and the RSU m during the time slot t, h_{v,m}(t) denotes a channel gain, σ² denotes a power of Gaussian white noise, and δ_{v,m} denotes a path loss.

The communication transmission rate SNR_{v,m}(t) between the vehicle v and the RSU m may be expressed as:

$${R}_{v , m} ( t ) = {B}_{v , m} ( t ) log ( 1 + S N {R}_{v , m} ( t ) ) , \qquad ( 6 )$$

where B_{v,m}(t) denotes a channel bandwidth of the communication link between the vehicle v and the RSU m.

The SNR_{v,m}(t) between the supplier of the cloud and the BS during the time slot t is expressed by the following formula:

$$S N {R}_{n} ( t ) = \frac{{p}_{n} ( t ) {h}_{n} ( t )}{{σ}^{2}} , \qquad ( 7 )$$

where pₙ(t) denotes the transmission power between the supplier and the BS in the time slot t, and hₙ(t) denotes the channel gain in the time slot t.

A downlink transmission rate from the supplier of the cloud to the BS may be expressed as:

$${R}_{n} ( t ) = {B}_{n} ( t ) log ( 1 + S N {R}_{n} ( t ) , \qquad ( 8 )$$

where Bₙ(t) denotes a channel bandwidth of the communication link between the cloud and the BS in the time slot t.

The service caching model is an analytical model used to quantify a frequency of service requests of the vehicle. The service caching model provides a quantitative basis for caching decisions of the MEC server by counting and calculating the frequency of requests for various services.

In some embodiments, the construction of the service caching model may include: defining a set of cached services as k∈{1,2,3 . . . , K}, providing, by the supplier of the cloud, services requested by the vehicle to the BS, and forwarding, by the BS, the data of the service to the vehicle via the RSU, wherein a set of size of the services is s∈{s₁, . . . , sₖ, . . . , S_{K}}, the unit is in bits.

In some embodiments, the system model constructs the service caching model including: calculating a service frequency pₖ(t), obtaining a caching decision x_{n,k}(t) for a service k based on the service frequency φₖ(t), x_{n,k}(t)=1 indicating that the MEC server n caches the service k from the supplier during the time slot t, x_{n,k}(t)=0 indicating that the MEC server n does not cache the service k during the time slot t; and calculating a caching cost

$${C}_{all}^{cost} ( t )$$

for a vehicle requesting the service (also be referred to as a vehicle request service) based on the caching decision x_{n,k}(t) for the service k.

In some embodiments, due to the limited cache capacity Sₘₐₓ of the MEC server in the BS, the MEC server is unable to cache all the services required by vehicles. As a result, the present disclosure defines the service frequency φₖ(t)∈[0,1].

The service frequency φₖ(t) quantifies the hotness of the vehicles request for the service k. The larger the service frequency φₖ(t), the higher the frequency of all vehicles requesting the service k. When the service frequency φₖ(t) is zero, it indicates that no vehicle requests the service k.

In some embodiments, the service frequency φₖ(t) may be expressed as a ratio of a request count from the vehicles to the service k to a total request count of all services, and a set of service frequency of all services (service 1, service 2, . . . service k, service K) during the time slot t is: Θ(t)={φ₁(t),φ₂(t), . . . , φₖ(t), . . . , φ_{K}(t)}.

In some embodiments, the BS caches only the services that are frequently requested by the vehicles from the supplier of the cloud; the BS updates the service frequency after a time period based on historical request records of the vehicles in the coverage region as counted by the RSU.

In some embodiments, the MEC server makes the caching decision based on the service frequency. For example, a service may be considered to be frequently requested by a vehicle if a service frequency φₖ(t) of the service is higher than a preset frequency threshold. When a service is frequently requested by a vehicle, the BS caches the service from the supplier of the cloud and provides the service to the vehicle, thereby reducing system latency and improving quality of service (QoS).

In some embodiments, the caching decision is defined as x_{n,k}(t)={0,1}, with x_{n,k}(t)=1 indicating that during the time slot t, the MEC server n caches the service k from the supplier of the cloud; and x_{n,k}(t)=0 indicating that during the time slot t, the MEC server n does not cache the service k, i.e., it indicates that the MEC server has stored the service k.

The caching cost may measure a price paid for caching a service. The higher the caching cost, the greater the expense to migrate the service.

In some embodiments, the caching cost

$${C}_{all}^{cost} ( t )$$

may be determined in a variety of ways, e.g., the cloud server may determine a count of caching times for the service k based on the caching decisions x_{n,k}(t) of different MEC servers, and the caching cost

$${C}_{all}^{cost} ( t )$$

is positively correlated to the count of caching times for the service k and to the size sₖ of the service k. The more times the service k is cached, the larger the size, the larger the bandwidth usage when caching the service k, and the larger the storage space usage of the MEC server, the higher the caching cost

$${C}_{all}^{cost} ( t ) .$$

In some embodiments, the system model calculates a latency t_{v,k}(t) and an energy consumption E_{v,k}(t) generated by each vehicle v based on the caching decision x_{n,k}(t) for the service k; calculates a total latency T(t) and a total energy consumption E(t) generated by all vehicles based on the latency t_{v,k}(t) and the energy consumption E_{v,k}(t); and determines the caching cost

$${C}_{all}^{cost} ( t )$$

for the vehicle request service by weighted combining the total latency T(t) and the total energy consumption E(t). More descriptions of this part may be found in Formulas (12) to (17) and the related descriptions thereof.

In some embodiments of the present disclosure, by constructing a dynamic and intelligent service caching model, it is possible to dynamically perceive and predict the popularity and request probability of different services in a specific time slot t. This avoids resource waste caused by static or blind caching strategies and overall enhances the caching efficiency and resource utilization of the edge caching system.

In some embodiments, the system model calculates the service frequency φₖ(t) by: obtaining a binary variable e_{v,k}(t) indicating whether the vehicle v requests the service k in the time slot t, calculating a request count to the service k and a total request count to all services based on e_{v,k}(t), and calculating the service frequency φₖ(t) for the service k based on the request count to the service k and the total request count to all services.

e_{v,k}(t) denotes a binary variable recording whether the service k is requested by the vehicle v in time slot t, which is expressed as:

$${e}_{v , k} ( t ) = \{ \begin{matrix}1 , & vehicle v requests service k \\ 0 , & vehicle v does not request service k\end{matrix} . \qquad ( 9 )$$

Assuming that during the time slot t, a UV requests at most one caching service, i.e., it satisfies:

$${\sum }_{k = 1}^{K} {e}_{v , k} ( t ) \leq 1. \qquad ( 10 )$$

During the time slot t, the service frequency φₖ(t) may be expressed as:

$${φ}_{k} ( t ) = \frac{{\sum }_{v = 1}^{V} {e}_{v , k} ( t )}{{\sum }_{k = 1}^{K} {\sum }_{v = 1}^{V} {e}_{v , k} ( t )} , \qquad ( 11 )$$

where

$${\sum }_{v = 1}^{V} {e}_{v , k} ( t )$$

denotes the request count for the service k from all vehicles in the time slot t, and

$${\sum }_{k = 1}^{K} {\sum }_{v = 1}^{V} {e}_{v , k} ( t )$$

denotes the total request count for all services from all vehicles in the time slot t.

In some embodiments of the present disclosure, the process for calculating the service frequency φₖ(t) relies on request data during the current time slot, which enables φₖ(t) to quickly capture the dynamic changes in the demand of the user. At the same time, calculating the service frequency φₖ(t) provides a quantitative index for the construction of subsequent caching decisions, making the decision-making process more scientific and reliable.

In some embodiments, the system model calculates the caching cost

$${C}_{all}^{cos t} ( t )$$

for the vehicle request services based on the caching decision x_{n,k}(t) for the service k by: calculating, based on the caching decision x_{n,k}(t) for the service k, the latency t_{v,k}(t) and the energy consumption E_{v,k}(t) generated by each vehicle v; calculating, based on the latency t_{v,k}(t) and the energy consumption E_{v,k}(t), the total latency T(t) and the total energy consumption E(t) generated by all vehicles; and weighted combining the total latency T(t) and the total energy consumption E(t) to obtain the caching cost

$${C}_{all}^{cost} ( t )$$

for the vehicle service requests.

In some embodiments, due to the limited storage capacity of the MEC server, it is not possible to cache all types of services, and thus, the MEC server n is required to satisfy a storage capacity limit:

$${\sum }_{k = 1}^{K} {x}_{n , k} ( t ) {s}_{k} \leq {S}_{max} , \qquad ( 12 )$$

where Sₘₐₓ denotes an upper limit of storage capacity of the MEC server. Therefore, the latency t_{v,k}(t) and the energy consumption t_{v,k}(t) generated by the vehicle v during the request service caching process may be expressed as:

$${t}_{v , k} ( t ) = \frac{{s}_{k}}{{R}_{v , m} ( t )} + {x}_{n , k} ( t ) \frac{{s}_{k}}{{R}_{n} ( t )} , \qquad ( 13 )$$

$${E}_{v , k} ( t ) = {p}_{v , m} ( t ) \frac{{s}_{k}}{{R}_{v , m} ( t )} + {x}_{n , k} ( t ) {p}_{n} ( t ) \frac{{s}_{k}}{{R}_{n} ( t )} , \qquad ( 14 )$$

where sₖ denotes the size of the vehicle request service k, x_{n,k}(t) denotes the caching decision in the time slot t, p_{v,m}(t) denotes the transmission power between the vehicle v and the RSU m in the time slot t, pₙ(t) denotes the transmission power between the supplier and the BS in the time slot t, R_{v,m}(t) denotes the communication transmission rate between the vehicle v and the RSU m in the time slot t, and Rₙ(t) denotes the downlink transmission rate from the supplier of the cloud to the BS in the time slot t. More descriptions of the pₙ(t), p_{v,m}(t), Rₙ(t), and Rₙ(t) may be found in Formulas (6) to (8).

The total latency T(t) and the total energy consumption E(t) generated by all vehicles are:

$$T ( t ) = {\sum }_{v = 1}^{V} {\sum }_{k = 1}^{K} {t}_{v , k} ( t ) , \qquad ( 15 )$$

$$E ( t ) = {\sum }_{v = 1}^{V} {\sum }_{k = 1}^{K} {E}_{v , k} ( t ) . \qquad ( 16 )$$

In some embodiments, to reduce latency, the RSU module may be overclocked, but this would lead to an increase in energy consumption; whereas to reduce energy consumption, the RSU module may be underclocked, but this would result in a decrease in communication transmission rates, leading to an increase in latency. Thus, it is necessary to comprehensively consider the total latency and total energy consumption in order to reduce the caching cost.

In some embodiments, the caching cost

$$C {}_{all}^{cost} ( t )$$

is positively correlated with the total latency T(t) and the total energy consumption E(t).

In some embodiments, the caching cost

$${C}_{all}^{cos t} ( t )$$

may be expressed as a weighted sum of latency and energy consumption as in the following formula:

$${C}_{all}^{cost} ( t ) = η T ( t ) + ( 1 - η ) E ( t ) , \qquad ( 17 )$$

where η∈[0,1] denotes weight factors of the latency and the energy consumption, and η may be preset based on a priori experience.

The task migration model is a decision model for migrating the currently performed service k to the new RSU when the vehicle leaves the coverage of the old RSU. The task migration model ensures the continuity of service data transmission by accurately determining a migration triggering condition and selecting an appropriate new RSU, thereby improving service quality and reducing transmission latency.

In some embodiments, the task migration model involves: considering vehicle mobility, if the current RSU cannot fully forward the service requested by the vehicle within the coverage of the current RSU, the task may be migrated from the current RSU to the next nearest RSU to the vehicle, thereby enhancing the quality of service (QoS) and reducing the latency generated during the transmission process of service data.

In some embodiments, D_{m,v}^{max} is defined as a maximum data amount transmittable to the vehicle v within the coverage 2L₁ of the RSU m, and D_{m,v}^{max} may be expressed as:

$${D}_{m , v}^{max} = {\int }_{0}^{\frac{2 {L}_{1}}{{a}_{v}}} {R}_{v , m} ( t ) dt . \qquad ( 18 )$$

In the above formula, if

$${s}_{k} > {D}_{m , v}^{max} ,$$

it means that the current RSU m cannot satisfy the requirement of the service k. In order to ensure stable and continuous provision of the service k to the UV, task migration must be initiated, where sₖ denotes the size of the vehicle request service k. More descriptions of the task migration may be found in S2 and related descriptions thereof.

In some embodiments of the present disclosure, by performing a weighted combination of the total latency T(t) and the total energy consumption E(t) to obtain the caching cost

$${C}_{all}^{cos t} ( t )$$

for the vehicle request service, two of the most critical performance dimensions, i.e., the total latency T(t) and the total energy consumption E(t), in Internet of Vehicles (IoV) and edge computing are comprehensively considered, ensuring that the system achieves a balance between both dimensions, thereby reflecting real-world user experience and system overhead. Furthermore, the weighted combination enables this approach to adapt to various optimization strategies and business models of different network operators and service providers, enhancing its versatility and adaptability.

In S2, a joint optimization problem of service caching and task migration is constructed based on the service caching model and task migration model.

In some embodiments, constructing the task migration model includes: representing the maximum data amount transmittable to the vehicle v within the coverage of the RSU m as

$${D}_{m , v}^{max} ,$$

sₖ denotes the size of the vehicle request service, and when

$${s}_{k} > {D}_{m , v}^{max} ,$$

it means that task migration occurs, and when

$${s}_{k} \leq {D}_{m , v}^{max} ,$$

it means that no task migration occurs; and representing the RSU migration decision as W_{v,k}(t)∈{0,1,2,3 . . . }, i.e., the count of RSU migrations during the vehicle request service; representing the BS migration decision as mig_{v,n}(t)∈{0,1}, wherein mig_{v,n}(t)=1 denotes that the vehicle v drives away from the coverage of the current BS, and mig_{v,n}(t)=0 denotes that the vehicle v does not drive away from the coverage of the current BS; calculating the total migration cost

$${C}_{all}^{mig} ( t )$$

of the vehicle service request based on the RSU migration decision and the BS migration decision, where K denotes a count of services, V denotes a count of vehicles, N denotes a count of all MEC servers, and Sₖ denotes the size of the service k.

In some embodiments, the system model calculates the total migration cost

$${C}_{all}^{mig} ( t )$$

of the vehicle request service based on the RSU migration decision and the BS migration decision by: obtaining a unit migration cost H₁ for migrating the service k to the rest of the RSUs within the coverage of the current BS and a unit migration cost H₂ for migrating the service k to the RSUs outside of the coverage of the current BS; calculating the migration cost

$${C}_{v , k}^{mig} ( t )$$

for the vehicle request service k of the vehicle v based on the unit migration cost H₁, the unit migration cost H₂, the size Sₖ of the service k, the RSU migration decision, and the BS migration decision; and calculating the total migration cost

$${C}_{all}^{mig} ( t )$$

for vehicle request service k based on the migration cost

$${C}_{v , k}^{mig} ( t ) .$$

The unit migration cost is a quantitative indicator that measures the cost (e.g., energy consumption, latency, etc.) incurred per unit data volume when a service is migrated between different RSUs or BSs. The higher the unit migration cost, the greater the expense to migrate the service.

In some embodiments, during a process of task migration, two scenarios may occur: in the first scenario, the vehicle v drives out of the coverage of the current RSU but does not go beyond the coverage of the current BS; and in the second scenario, the vehicle v drives out of the coverage of the current RSU and goes beyond the coverage of the current BS. The migration costs incurred in these two scenarios are different. The unit migration cost for the first scenario is defined as H₁, and the unit migration cost for the second scenario is defined as H₂.

In some embodiments, the migration cost for migrating the service k to any other RSU is defined as H₁sₖ, where H₁ denotes the unit migration cost, and the migration cost for migrating the service k to any other RSU under other BS is defined as H₂sₖ, where Sₖ denotes the size of the vehicle request service. mig_{v,n}∈{0,1} is defined as a binary variable indicating whether the vehicle v drives away from the current BS, where mig_{v,n}(t)=1 indicates that the switching of the BS has occurred, and mig_{v,n}(t)=0 indicates that the switching of the BS has not occurred. For the simplicity of the model, it is assumed that the switching of the BS occurs only once.

In some embodiments, the system model calculates the migration cost

$${C}_{v , k}^{mig} ( t )$$

for the vehicle request service k of the vehicle v by:

$${C}_{v , k}^{mig} ( t ) = {W}_{v , k} ( t ) {H}_{1} {s}_{k} + {mig}_{v , n} ( t ) {H}_{2} {s}_{k} , \qquad ( 19 )$$

where W_{v,k}(t) denotes the RSU migration decision, which indicates the count of RSU migrations during a process the vehicle v requests the service k during the time slot t, and mig_{v,n}(t) denotes the BS migration decision, which indicates a binary variable indicating whether the vehicle v drives away from the current BS during the time slot t.

The total migration cost of all vehicle request services may be expressed as:

$${C}_{all}^{mig} ( t ) = {\sum }_{v = 1}^{V} {\sum }_{k = 1}^{K} {C}_{v , k}^{mig} ( t ) . \qquad ( 20 )$$

Because of the limited coverage of each RSU, the vehicle v traveling to a different location needs to switch to connect to RSUs in different regions, i.e., RSU migration.

The count W_{v,k}(t) of RSU migrations refers to a total count of RSU migrations performed by the vehicle v during the duration of the service k. It may be understood that the farther the vehicle v travels in the duration, the more RSU coverages the vehicle v passes through, and the greater the count of RSU migrations.

In some embodiments, the system model may determine the count W_{v,k}(t) of RSU migrations by the following operations.

In some embodiments, the system model may determine a travel trajectory of the vehicle and an RSU coverage, determine whether the vehicle has crossed a boundary of the RSU coverage based on the travel trajectory and the RSU coverage, and determine a count of RSU migrations in the vehicle request service based on whether the vehicle has crossed the boundary of the RSU coverage.

In some embodiments, the system model may determine the travel trajectory of the vehicle based on a historical vehicle location and a real-time vehicle location. The historical vehicle location and the real-time vehicle location may be determined using a speedometer and a historical travel log.

The RSU coverage refers to the maximum range in which the RSU can guarantee the communication quality. When the vehicle is located outside the RSU coverage, the latency and data volume of the communication between the vehicle and the RSU do not satisfy the requirement of the service k.

In some embodiments, the system model may determine the RSU coverage in a plurality of ways. For example, in open terrain, the RSU coverage is a circular region, with a radius of the circular region positively correlating to the ability of the RSU to send and receive signals; in complex terrain, the RSU coverage is an irregular polygonal region, with an area of the irregular polygonal region positively correlating to the ability of the RSU to send and receive signals. The coverage of the irregular polygon region may be determined by field measurement or simulation.

In some embodiments, the system model may determine whether the vehicle has crossed the boundary of the RSU coverage based on the travel trajectory and the RSU coverage. For example, the system model may map the corresponding RSU coverages for all RSUs in a geographic information system (GIS). The system model may determine whether the vehicle, when traveling, has crossed the boundary of the RSU coverage, based on a spatial topological relationship. The spatial topological relationship may include a boundary algebra manner, a cross-product judgment manner, or the like.

In some embodiments, the system model may determine the count of RSU migrations in the vehicle request service based on whether the vehicle has crossed the boundary of the RSU coverage. For example, the system model may initialize the quantity W_{v,k}(t) to 0 and iteratively traverse the vehicle's location coordinates in the geographic information system (GIS) based on the travel trajectory of the vehicle.

Each time the vehicle crosses the boundary of an RSU coverage, the quantity W_{v,k}(t) is incremented by 1 until the vehicle reaches its destination along the travel trajectory, resulting in the final value of W_{v,k}(t). If the vehicle remains within the coverage of the same RSU throughout the entire journey, the quantity W_{v,k}(t)=0.

In some embodiments, when the vehicle is switched from the old RSU to the new RSU, if both the old RSU and the new RSU correspond to the same BS, there is no need to switch the BS, and the task migration belongs to the first scenario, wherein the binary variable indicating whether the vehicle v is driven away from the current BS satisfies mig_{v,n}(t)=0. When the vehicle is switched from the old RSU to the new RSU, if the old RSU and the new RSU correspond to two BSs, respectively, then the BS needs to be switched, and the task migration belongs to the second scenario, wherein the binary variable indicating whether the vehicle v is driven away from the current BS satisfies mig_{v,n}(t)=1.

In some embodiments of the present disclosure, by precisely quantifying migration costs at different levels and closely coupling them with the real-time mobility of vehicles, the system can respond in real time to the movement state of each vehicle in each time slot, and proactively estimate potential future migration costs, so that make more forward-looking caching or migration decisions, thereby reducing service interruption time and system operational costs caused by vehicle mobility.

The caching process and task migration process for the vehicle request service may occur simultaneously. Therefore, evaluating system performance requires considering both the performance of service caching and the performance of task migration. Accordingly, the present disclosure establishes a joint optimization problem for service caching and task migration, with an objective of minimizing the weighted sum of latency and energy consumption generated during the service caching process for all vehicles, as well as the migration costs.

In some embodiments, the joint optimization problem for service caching and task migration is expressed as:

$$max - ( {C}_{all}^{cos t} ( t ) + {C}_{all}^{mig} ( t ) ) , \qquad ( 21 a )$$

$$\begin{matrix}s . t . {\sum }_{k = 1}^{K} {e}_{v , k} ( t ) \leq 1 & v ∈ \{ 1 , 2 , … … , V \}\end{matrix} , \qquad ( 21 b )$$

$$\begin{matrix}{\sum }_{k = 1}^{K} {x}_{n , k} ( t ) {s}_{k} \leq {S}_{max} & n ∈ \{ 1 , 2 , 3 , … … , N \}\end{matrix} , \qquad ( 21 c )$$

$$\begin{matrix}{x}_{n , k} ( t ) ∈ \{ 0 , 1 \} & n ∈ \{ 1 , 2 , 3 , … … , N \} , k ∈ \{ 1 , 2 , 3 , … … , K \}\end{matrix} , \qquad ( 21 d )$$

$$\begin{matrix}{W}_{v , k} ( t ) \geq 0 & v ∈ \{ 1 , 2 , … … , V \} , k ∈ \{ 1 , 2 , 3 , … … , K \}\end{matrix} , \qquad ( 21 e )$$

$${mig}_{v , n} \begin{matrix}( t ) ∈ \{ 0 , 1 \} & v ∈ \{ 1 , 2 , … … , V \} , n ∈ \{ 1 , 2 , 3 , … … , N \}\end{matrix} , \qquad ( 21 f )$$

$$\begin{matrix}0 < {p}_{v , m} ( t ) \leq {p}_{max} & v ∈ \{ 1 , 2 , … … , V \} , m ∈ \{ 1 , 2 , … … , M \}\end{matrix} , \qquad ( 21 g )$$

$$\begin{matrix}0 < {p}_{n} ( t ) \leq {p}_{max} & n ∈ \{ 1 , 2 , 3 , …… , N \}\end{matrix} , \qquad ( 21 h )$$

where

$${C}_{all}^{cos t} ( t )$$

denotes the caching cost of the vehicle request service,

$${C}_{all}^{mig} ( t )$$

denotes the total migration cost of the vehicle request service, e_{v,k}(t) denotes a binary variable indicating whether the vehicle v performs the vehicle request service k during the time slot t, K denotes the count of vehicle request services, V denotes the count of vehicles, N denotes the count of MEC servers, M denotes the count of RSUs, x_{n,k}(t) denotes the caching decision indicating whether the MEC server n caches the vehicle request service k during the time slot t, sₖ denotes the size of the vehicle request service, Sₘₐₓ denotes the storage capacity limit of the MEC server n, W_{v,k}(t) denotes the RSU migration decision indicating the count of RSU migrations during the process of requesting the service k by the vehicle v during the time slot t, mig_{v,n}(t) denotes the BS migration decision, which indicates a binary variable indicating whether the vehicle v drives away from the current BS during the time slot t, p_{v,m}(t)) denotes the transmission power between the vehicle v and the RSU m during the time slot t, pₙ(t) denotes the transmission power between the supplier and the BS, and pₘₐₓ denotes the maximum transmission power.

In some embodiments, formula (21a) is a constraint on the count of services requested to be cached, in that the vehicle can request at most one service to be cached in a time slot; formula (21b) is a constraint on the cache capacity of the MEC server, in that the size of all services cached by the MEC server must not exceed the maximum cache capacity; formulas (21c), (21d), and (21e) are constraints on the caching decision and the migration decision; and formula (21f) and (21g) are constraints on transmission power.

Since the aforementioned problem (i.e., the joint optimization problem) is a mixed-integer non-convex problem, it is challenging to solve. Furthermore, in dynamic Internet of Vehicles scenarios, channel conditions, UV states, and the resources of MEC servers are time-varying. As the count of edge devices gradually increases, the dimensionality of the system state space becomes very large. Using traditional optimization methods would result in extremely high computational complexity, making it difficult to derive optimal caching and migration strategies. Thus, the present disclosure employs deep reinforcement learning to address the joint optimization problem.

In some embodiments of the present disclosure, by precisely quantifying network migration costs at different levels and closely coupling them with the real-time mobility of vehicles, the system can respond in real time to the movement state of each vehicle in each time slot, and proactively estimate potential future migration costs, so that make more forward-looking caching or migration decisions, thereby reducing service interruption time and system operational costs caused by vehicle mobility.

In S3, the joint optimization problem is abstracted into a Markov decision process.

In some embodiments, the state space of the Markov decision process is O(t)={P(t),Θ(t),D}, the action space is A(t)={X(t),N(t),M(t)}, and the reward function is

$$R ( t ) = - ( {C}_{all}^{cos t} ( t ) + {C}_{all}^{mig} ( t ) ) ;$$

where P(t) denotes a set of vehicle locations during the time slot t, Θ(t) denotes the set of service frequencies φₖ(t) during the time slot t, D denotes the set of maximum data amounts

$${D}_{m , v}^{max}$$

transmittable to the vehicles within the RSU coverage, X(t) denotes the set of caching decisions x_{n,k}(t), W(t) denotes the set of RSU migration decisions W_{v,k}(t), and M(t) denotes the set of BS migration decisions mig_{v,n}(t).

The Markov decision process is a mathematical model used for sequential decision making, where the Markov decision process learns the optimal strategy to maximize the long-term payoff in a stochastic environment through the interactions of the intelligences with the environment.

In some embodiments, the Markov decision process includes a state space O(t), an action space A(t), and a reward function R(t). The state space O(t) is the set of dynamic environment features in which the IoV system is located during the time slot t, which is equivalent to the input of the Markov decision process, including the locations of all vehicles and the frequencies of all services. The action space A(t) is the set of decisions that can be executed by the system model during the time slot t, which contains all the possible current caching decisions and migration decisions, which is equivalent to a count of candidate proposals. The reward function R(t) is used to judge the advantages and disadvantages of each candidate proposal, so as to determine an optimal caching decision and an optimal migration decision (action aₙ(t)) in the action space A(t), and finally determine the (action aₙ(t)) as an output.

The present disclosure transforms an optimization problem into a Markov decision process, views an MEC server as an intelligence body, and defines the tuple {O, A, R, O′} to describe the above process, where O={O₁, O₂, . . . , O_{N}} is the set of state spaces of the intelligence body, A={A₁, A₂, . . . , A_{N}} is the set of action spaces of the intelligence body, R={R₁, R₂, . . . , R_{N}} is the set of rewards. During the time slot t, the intelligence body N adopts the strategy πₙ:Oₙ→Aₙ based on the local observation oₙ(t)∈Oₙ and chooses the corresponding action aₙ(t)∈Aₙ, which results in the corresponding reward rₙ(t)∈Rₙ.

$${O}^{′} = \{ {O}_{1}^{′} , {O}_{2}^{′} , … , {O}_{N}^{′} \}$$

is the set of next states of the intelligence body after the execution of the action.

### 1) State Space

In the time slot t, the intelligence body first observes and senses the environment state, and then obtains experience and updates the decision-making strategy through information of the environment state. The environment state of the present disclosure is O(t)={P(t),Θ(t),D}, which is expressed as follows.

P(t)={(x₁(t),y₁(t)), . . . , (xᵥ(t),yᵥ(t)), . . . , (xᵥ(t),yᵥ(t))}: the vehicle location during the time slot t;

Θ(t)={φ₁(t), . . . φₖ(t) . . . , φ_{K}(t)}: the service frequency during the time slot t;

$$D = \{ {D}_{1 , 1}^{{max}_{m , v}^{{max}_{M , V}^{max}}} :$$

the maximum data amount transmittable to the vehicle within the coverage of the RSU.

### 2) Action Space

In the whole system, the intelligence body has to dynamically adjust its behavior during each time slot according to the system state, so as to maximize the long-term benefits. The action space of the present disclosure may be represented as A(t)={X(t),N(t),M(t)} as follows.

X(t)={x_{1,1}(t), . . . , x_{n,k}(t), . . . , x_{N,K}(t)}: the caching decision, where x_{n,k}(t)∈{0,1}. When the MEC server n caches the service k, x_{n,k}(t)=1. Otherwise x_{n,k}(t)=0.

W(t)={W_{1,1}(t), . . . W_{v,k}(t), . . . , W_{V,K}(t)}: the RSU migration decision, which determines whether the RSU is migrated and the count of times it is migrated during the vehicle request service, where N_{v,k}(t)∈{0,1,2,3 . . . }, and N_{v,k}(t)=0 indicates that the RSU has not migrated;

M(t)={mig_{1,1}(t), . . . , mig_{v,n}(t), . . . , mig_{V,N}(t)}: the BS migration decision, where mig_{v,n}(t)∈{0,1}, and when the vehicle v drives away from the coverage of the MEC server n, mig_{v,n}(t)=1, otherwise mig_{v,n}(t)=0.

### 3) Reward Function

The system reward for each time slot is the sum of the rewards of all vehicles, and the present disclosure establishes a system reward function based on an objective function in the optimization problem, and thus, the system reward function may be expressed as:

$$R ( t ) = - ( {C}_{all}^{cos t} + {C}_{all}^{mig} ( t ) ) = - ( η T ( t ) + ( 1 - η ) E ( t ) + {\sum }_{v = 1}^{V} {\sum }_{k = 1}^{K} {C}_{v , k}^{mig} ( t ) ) = - ( η {\sum }_{v = 1}^{V} {\sum }_{k = 1}^{K} {t}_{v , k} ( t ) + ( 1 - η ) {\sum }_{v = 1}^{V} {\sum }_{k = 1}^{K} {E}_{v , k} ( t ) + {\sum }_{v = 1}^{V} {\sum }_{k = 1}^{K} {C}_{v , k}^{mig} ( t ) ) . \qquad ( 22 )$$

In some embodiments of the present disclosure, the joint optimization problem is modeled as a Markov decision process, and by analyzing in real-time a state space consisting of a set of vehicle locations, a set of service frequencies, and a set of maximum transmitted data volumes and scheduling computational tasks for collaborative execution among the local RSUs, the cloud, and the vehicles, it not only avoids network congestion but also reduces service latency and bandwidth consumption. Ultimately, it provides users with a consistent, stable, efficient, and seamless Internet of Vehicles experience at a lower overall operational cost.

In S4, an optimal caching decision and an optimal migration decision are determined by solving the joint optimization problem of service caching and task migration using a multi-intelligence body reinforcement learning method based on the Markov decision process.

The multi-intelligence body reinforcement learning method is a reinforcement learning method that combines centralized training and decentralized execution to enable each intelligence body to collaboratively learn optimal decision-making strategies by using a plurality of MEC servers as intelligence bodies in service caching and task migration scenarios. By constructing a Markov decision process model, the multi-intelligence body reinforcement learning method allows the intelligence bodies to gain experience through interactions in a simulated environment, and finally obtains a trained model through continuous machine learning and training. This model can automatically determine and execute the optimal caching and migration decisions during the time slot t based on the actual situation of the UV.

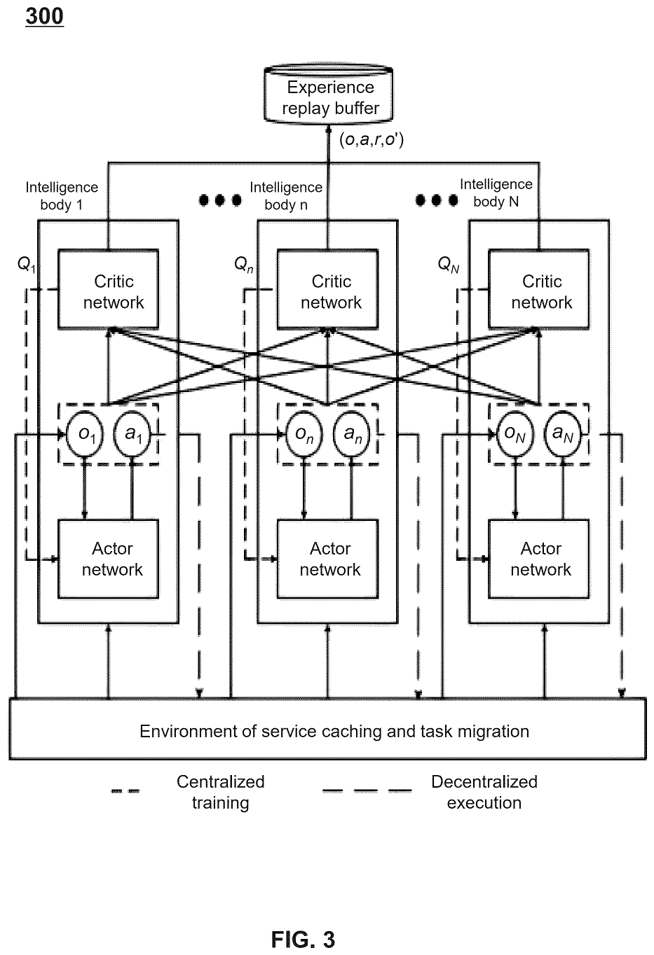

More descriptions of the multi-intelligence body reinforcement learning method may be found in FIG. 3 and related descriptions thereof.

In some embodiments of the present disclosure, by establishing a service caching model to enable the MEC server to cache service data required by the vehicle from the supplier in advance, it eliminates the need to request data from the supplier each time, thereby reducing the latency and energy consumption generated during the service request process and improves system performance. By establishing a task migration model to allow the MEC server to implement task migration, it transfers ongoing tasks or services from one edge node to another to optimize resource utilization, reduce latency, and ensure service continuity and stability. By jointly optimizing the service caching and task migration, the latency and energy consumption during the service caching process, as well as the costs associated with the task migration, are further reduced, thereby enhancing the overall quality of service of the system.

It should be noted that the above description of steps S1-S4 is provided for the purpose of example and illustration only, and does not limit the scope of application of this specification. For a person skilled in the art, various corrections and changes may be made to the process steps S1-S4 under the guidance of this specification. However, these corrections and changes remain within the scope of this specification.

FIG. 3 is a framework diagram of a multi-intelligence body reinforcement learning method (MADDPG algorithm) according to some embodiments of the present disclosure.

In the present disclosure, the framework of the MADDPG consists of an environment and N intelligence bodies, each of the intelligence bodies has a centralized training phase and a decentralized execution phase. In the centralized training phase, the MEC server aggregates state-action information from all vehicles and RSUs to train a deep reinforcement learning DRL model, wherein each of the intelligence bodies may obtain a global view of the learning environment, thereby enabling collaborative learning with other intelligence bodies, which makes the learning environment more stable and thus improves the convergence performance. After training at the MEC server, the learned parameters are downloaded to each vehicle, which allows the vehicle to execute the model for decision making based on locally observed information. In the decentralized execution process, after each intelligence body has been adequately trained, each Actor network (actor) is allowed to choose the appropriate action on its own based on the state, without the need for the states or actions of other intelligence bodies.

π={π₁, . . . , πₙ, . . . , π_{N}} is defined as the set of strategies of all intelligence bodies. θ={θ₁, . . . θₙ . . . , θ_{N}} is defined as the parameter set of the corresponding strategy, and each intelligence body obtains the optimal strategy

$${π}_{{θ}_{n}}^{*} = arg {max}_{{θ}_{n}} R ( {θ}_{n} )$$

by updating the parameter θₙ, where R(θₛ) denotes the objective function of the intelligence body, i.e., an expected return of training. MADDPG is constructed based on Actor-Critic networks, where the Actor network (actor) generates a deterministic action A(t) during the time slot t via an action network, while the Critic network (critic) evaluates the action A(t) of the actor via a target network and adjusts the parameters of the Actor network based on the evaluation result. Through the synergistic action of the Actor network and the Critic network, the Actor network may be optimized and updated, and finally, a fully trained Actor network is obtained, which is capable of selecting the optimal action from several optional actions available during the time slot t.

During the training, the actor updates the Actor network by calculating the gradient of the objective function:

$${∇}_{{θ}_{n}} R ( {π}_{n} ) = {E}_{o , a ∼ G} [ {∇}_{{θ}_{n}} {Q}_{n}^{π} ( o , {a}_{1} , … , {a}_{n} , … , {a}_{N} ) \cdot {∇}_{{θ}_{n}} {π}_{n} ( {a}_{n} \vert {o}_{n} ) ] \qquad ( 23 )$$

where o={o₁, . . . , oₙ, . . . , o_{N}} denotes an observation set,

$${Q}_{n}^{π} ( o , {a}_{1} , … , {a}_{n} , … , {a}_{N} )$$

denotes a centralized action-value function of the intelligence bodies, a₁, . . . aₙ . . . , a_{N} denote the actions of all the intelligence bodies, and G denotes an empirical replay region containing a plurality of sample sets (o, a, r, o′).

In addition, the Critic network updates the behavioral Q-function

$${Q}_{n}^{π} ( )$$

in a way that minimizes the loss function as follows:

$$L ( {θ}_{n} ) = {E}_{o , a , r , {o}^{′}} [ {( {y}_{n} - {Q}_{n}^{π} ( o , {a}_{1} , … {a}_{n} … , {a}_{N} ) )}^{2} ] , \qquad ( 24 )$$

where

$${y}_{n} = {r}_{n} + γ {Q}_{n}^{π} ( {o}^{′} , {a}_{1}^{′} , … {a}_{n}^{′} … , {a}_{N}^{′} ) \vert {a}_{n}^{′} = {π}_{n}^{′} ( {o}_{n} )$$

denotes a time-differential TD objective function,

$${π}_{n}^{′} ( {o}_{n} )$$

denotes an objective decision with parameter θₙ′, and rₙ denotes the reward.

Specifically, the training process is as follows:
Input: the empirical replay region G, a time step T, a greedy factor ε, a discount factor γ, and an update step δ;
Output: an optimal decision

$${π}_{{θ}_{n}}^{*}$$

and a maximal payoff r*(o,a);
Step 1, Initialization: a deep Q-network Q(o,a) is initialized using random weights θ and θ′, and the greedy factor is initialized to ε∈(0,1);
Step 2: the state is initialized to o₀←{P(t),Θ(t),D(t)}|ₜ₌₀;
Step 3: for each intelligence body MEC server n∈{1, 2 . . . , N}, an action an(t) is randomly selected based on the probability ε, wherein aₙ(t)=π_{θ}_{ₙ}(oₙ(t)); the action a(t)={a₁(t), . . . aₙ(t) . . . , a_{N}(t)} is performed; the system reward r(t) and the new state o′ are observed; and (o(t), a(t), r(t), o′(t)) is stored to the empirical replay region G, where a(t)=A(t), r(t)=R(t), and o(t)=O(t);
Step 4: all the intelligence bodies are trained based on a small batch (o(t), a(t), r(t), o′(t)) randomly selected from G; the training process for each intelligence body consists of: representing yₙ as

$${y}_{n} = {r}_{n} + γ {Q}_{n}^{π} ( {o}^{′} , {a}_{1}^{′} , … , {a}_{n}^{′} , … , {a}_{N}^{′} ) \vert {a}_{n}^{′} = {π}_{n}^{′} ( {o}_{n} ) ,$$

updating the Critical network by minimizing the loss function L(θₙ):

$$L ( {θ}_{n} ) = {E}_{o , a , r , {o}^{′}} [ {( {y}_{n} - {Q}_{n}^{π} ( o , {a}_{1} , … {a}_{n} … , {a}_{N} ) )}^{2} ] ,$$

and updating the Actor network sampling the strategy gradient ∇_{θ}_{ₙ}R(πₙ):

$${∇}_{{θ}_{n}} R ( {π}_{n} ) = {E}_{o , a \sim G} [ {∇}_{{θ}_{n}} {Q}_{n}^{π} ( o , {a}_{1} , … {a}_{n} … , {a}_{N} ) . {∇}_{{θ}_{n}} {π}_{n} ( {a}_{n} \vert {o}_{n} ) ]$$

Step 5: Update target network parameters for each intelligence body:

$${θ}_{n}^{′} ← {δθ}_{n} + ( 1 - δ ) {θ}_{n}^{′} ;$$

Step 6: return to step S3 until the preset time step T is reached;
Step 7, return to step S2 until the preset count of iterations F is reached.

The process employs a greedy strategy to select the actions of the intelligence bodies, and at each time point, each MEC server executes the actions and estimates the system reward, and stores the training information in the empirical replay region (Step 3). After performing each action, the MEC server proceeds to the next step to update the Actor network and Critic network, as well as the corresponding target network (Step 4). After the network update is complete, the update of the target network parameters of each intelligence body is performed (step 5). Iterate training is performed until the desired system reward performance is achieved.

In one embodiment, a task migration algorithm may also be used to obtain a migration decision as follows:

$$Input : {L}_{1} , {L}_{2} , {a}_{v} , {R}_{v , m} ( t ) ( v ∈ \{ 1 , 2 , …… , V \} , m ∈ \{ 1 , 2 , …… , M \} , t ∈ \{ 1 , 2 , 3 , …… , T \} ) {d}_{v , m} ( t ) ( v ∈ \{ 1 , 2 , …… , V \} , m ∈ \{ 1 , 2 , …… , M \} t ∈ \{ 1 , 2 , 3 , …… , T \} ) ;$$

$$Output : {N}_{v , k} ( t ) , {mig}_{v , n} ( t ) ;$$

Step 1: Initialization: N_{v,k}(t)=0, and mig_{v,n}(t)=0. The maximum data amount

$${D}_{m , v}^{max} = {\int }_{0}^{\frac{2 {L}_{1}}{{a}_{v}}} {R}_{v , m} ( t ) dt .$$

transmittable to the vehicle v within the coverage of the RSU m is calculated, wherein

$${D}_{m , v}^{max}$$

The difference between the maximum data amount

$${D}_{m , v}^{max}$$

and the service k is calculated to obtain the remaining data amount

$${D}^{res} = {s}_{k} - {D}_{m , v}^{max} ;$$

Step 2: If the remaining data amount D^{res}>0, the count of times the task migration occurs is counted such that W_{v,k}(t)=W_{v,k}(t)+1, and the RSU mₙₑₓₜ that is the closest to the vehicle v among the rest of the RSUs is selected as RSUmₙₑₓₜ=arg_{m∈M}min{d_{v,m}(t)}. The maximum data amounts

$${D}_{{m}_{next} , v}^{max}$$

transmittable to the vehicle v within the coverage of the RSU mₙₑₓₜ is calculated, and the remaining data amount D^{res} is updated according to the data volume

$${D}_{{m}_{next} , v}^{max}$$

wherein

$${D}^{res} = {D}^{res} - {D}_{{m}_{next} , v}^{max} ;$$

Step 3: Repeat step S2 until D^{res}≤0, i.e., cycle until all service program data is migrated;
Step 4: whether W_{v,k}(t)L₁>L₂ holds is determined, if so, representing mig_{v,n}(t) as mig_{v,n}(t)=1, and if not, representing mig_{v,n}(t) as mig_{v,n}(t)=0.

In this regard, the maximum data amount transmittable to the vehicle v within the coverage of the RSU m and the remaining data amount after transmission are first calculated (step 1). The count of times the task migration occurs is counted, the migrated RSU (the RSU closest to the vehicle) is found, and the remaining data amount is calculated, wherein the operations are repeated until all of the data of the service program has been migrated (steps 2 and 3). Whether the vehicle drives away from the current BS or not is determined (step 4).

In some embodiments, the system model may generate a caching instruction based on the optimal caching decision, the caching instruction including a target MEC server, a target caching time, and a target service; send the caching instruction to the target MEC server; control the target MEC server to cache the target service at the target caching time from a remote server, the target service including road emergency data, traffic safety information, broadcast and entertainment information; generate at least one of an RSU migration instruction and a BS migration instruction based on the optimal migration decision; send the at least one of the RSU migration instruction and the BS migration instruction to a corresponding OBU; control the OBU to send a connection request to at least one of a to-be-connected RSU and a to-be-connected BS; and control the OBU to establish a communication connection with at least one of the to-be-connected RSU and the to-be-connected BS through an assigned IP address and a wireless channel.

More descriptions of the RSU, the BS, and the MEC servers may be found in FIG. 1 and related descriptions thereof.

The optimal caching decision is an automated tuning scheme to regulate the service type and cache time cached by the MEC server. The optimal caching decision minimizes the caching cost of the vehicle request service while meeting the storage capacity limit of the MEC server.

The caching instruction refers to an instruction that controls the MEC server to cache an appropriate service from a supplier of the cloud within a specified time window.

In some embodiments, the caching instruction may include a target MEC server, a target caching time, a target service, or the like. The target MEC server refers to an MEC server that requires to cache a service. The target caching time refers to a retain time that the cached service is retained within the MEC server. The longer the target caching time, the greater the pressure on the storage capacity of the MEC server. The target service refers to the content of the service that the target MEC server needs to cache. The target service may include road emergency data, traffic safety information, and broadcast and entertainment information.

In some embodiments, the system model may generate the caching instruction based on the optimal caching decision and send the caching instruction to the target MEC server via a wireless channel to execute the caching instruction. The optimal caching decision may be determined based on the MADDPG algorithm. More descriptions of the MADDPG algorithm may be found in FIG. 3 and the associated descriptions.

In some embodiments, when the vehicle is traveling, the system model may determine MEC servers within a preset radius of the vehicle as the target MEC servers. As another example, since the vehicle needs to comply with traffic rules while traveling, when the vehicle is located on a complex roadway such as a one-way street or a viaduct, the system model may determine a passable road for the vehicle based on a navigation algorithm, and identify the passable MEC servers along the passable road as the target MEC servers.

In some embodiments, the system model may determine a target caching time based on the vehicle speed and a distance between the target MEC server and the vehicle. The faster the vehicle speed and the shorter the distance, the shorter the residence time of the vehicle within the coverage of the target MEC server, the shorter the target caching time, and vice versa.

In some embodiments, the system model may select a suitable target service based on the needs of the UV and the public service. For example, when a traffic accident occurs in the region where the vehicle is located, the system model may push road emergency data to all vehicles in the region and send emergency warnings to the UV according to the needs of the transportation department.

The migration instruction is an instruction that control the vehicle to switch connections to different devices. The migration instruction may include an RSU migration instruction and a BS migration instruction. Due to the fact that the vehicle passes through a plurality of RSUs and BSs while traveling, it is necessary to control the vehicle to switch connections in time while traveling through the migration instruction to ensure that the vehicle request service operates without interruption.

The RSU migration instruction is an instruction to migrate the vehicle request service between different RSUs. In some embodiments, the RSU migration instruction may include a to-be-connected RSU.

In some embodiments, the RSU to which the vehicle is being connected is typically the RSU closest to the vehicle, and thus the system model may identify an RSU that is the second-closest to the vehicle along the direction of travel of the vehicle, as the to-be-connected RSU.

The BS migration instruction is an instruction to migrate the vehicle request service between different BSs. In some embodiments, the BS migration instruction may include a to-be-connected BS when the vehicle has traveled to a preset location.

In some embodiments, since the geographical locations of RSUs and BSs remain basically unchanged, a BS may be pre-allocated to each RSU based on the spatial locational relationship between the RSUs and the BSs, and the BS corresponding to the to-be-connected RSU is determined as the to-be-connected BS. The pre-allocated manner may be such that the BS with the closest distance or the greatest signal strength is assigned to the RSU.

In some embodiments, when the system model detects that the vehicle meets a migration triggering condition, the system model may generate and issue a migration instruction. For example, due to the limited coverage of the RSU and the BS, and the low latency when the vehicle is closer to the RSU and the BS, when the latency of the vehicle to the RSU and BS exceeds a preset latency value, it may be determined that the vehicle is far from the currently connected RSU and BS and a migration should be carried out, at this time, the system model may generate and send a migration instruction to the OBU. As another example, when the bandwidth between the vehicle and the RSU and BS is less a preset bandwidth, at this point the system model may generate and send a migration instruction to the OBU.

In some embodiments, after receiving the migration instruction, the OBU, in accordance with the migration instruction, sends a connection request to at least one of the to-be-connected RSU and the to-be-connected BS through the assigned IP address and the wireless channel, thereby ensuring a seamless migration of services. The system model may select an IP address and wireless channel with the highest signal-to-noise ratio as the allocated IP address and wireless channel. More descriptions of determining the signal-to-noise ratio may be found in formula (7).

In some embodiments of the present disclosure, by generating the caching instruction to enable the target MEC server to cache the target service in advance, and generating the migration instruction to switch the connection between the vehicle and the RSU and the connection between the vehicle and the BS, it is possible to ensure that the vehicle seamlessly switches from one service point to another by the pre-planned migration instruction when moving at a high speed, which guarantees the continuity of the service, greatly reduces the risk of service interruption, and enhances the user experience.

In some embodiments, the state space further includes a future vehicle location and a future service frequency of the vehicle at a future time point. A time interval between the future time point and a current time point is less than the time slot t. The system model may determine the future vehicle location based on a real-time vehicle location by predictive processing; determine an estimated count of RSU migrations in the vehicle request service based on the future vehicle location; determine an estimated total migration cost for the vehicle; determine an estimated latency and an estimated energy consumption of the vehicle in the vehicle request service based on the future service frequency; determine an estimated caching cost during the process of the vehicle request service; and determine the optimal caching decision and the optimal migration decision based on the total migration cost, the caching cost, the estimated total migration cost, and the estimated caching cost.

More descriptions of the total migration cost, the optimal caching decision, and the migration decision may be found in FIG. 2 and related descriptions thereof.

In some embodiments, in traditional task migration techniques, the state space typically only includes information at the current time point. However, the IoV environment is highly dynamic, with vehicle locations and service types changing, and if the system model relies on only the information of the current time point to make a decision, it may make a sub-optimal solution due to a lack of foresight. Therefore, it is necessary to introduce the information of future time points, so that the system model can anticipate the vehicle locations and service types in advance, and thus plan the caching and migration strategies in advance, which can significantly improve the quality of decision making and the long-term benefits of the system.

The time slot t is a constraint limiting the interval between a future time point and the current time point. Since the IoV environment is highly dynamic, if the interval between the future time point and the current time point is too large, it may lead to distortion of the prediction, and thus it needs to be constrained by the time slot t. The time slot t may be preset by staff based on experience. More descriptions of the time slot t may be found in formula (9) to formula (11) and related descriptions thereof.

The future vehicle location may reflect the vehicle trajectory at a future time point. The future vehicle location may be expressed as a set of geographic coordinates of the vehicle at a future time point time.

In some embodiments, the system model may predict the future vehicle location based on a variety of ways.

For example, the system model may predict an estimated average vehicle speed at the future time point from the current time point based on the real-time vehicle speed and the historical vehicle speed, determine an estimated travel distance of the vehicle at the future time point based on the estimated average speed, and determine the future vehicle location based on the current vehicle location and the estimated travel distance. The estimation manner may be a linear fitting manner, a non-linear fitting manner, or the like.

In some embodiments, when the vehicle encounters a branch road, such as an intersection, the existence of a plurality of estimated paths results in the existence of a plurality of future vehicle locations. At this time, the system model may determine the most likely estimated path the vehicle will take based on a preset destination of the vehicle, frequently visited locations, etc., and determine the future vehicle location corresponding to the most likely estimated path as the required future vehicle location for current decision-making. Here, the real-time vehicle location, the real-time speed, and the historical speed may be obtained based on the GPS module of the OBU, the speedometer, and the historical driving logs.

In some embodiments, the system model may also determine the future vehicle location via a vehicle location model.

The vehicle location model refers to a model for estimating future vehicle locations. In some embodiments, the vehicle location model is a machine learning model. For example, the vehicle location model is any one or a combination of long short-term memory (LSTM) or other customized model structures, etc.

In some embodiments, an input of the vehicle location model includes a historical vehicle location, a real-time vehicle location, a historical speed, and a real-time speed; and an output of the vehicle location model includes future vehicle locations corresponding to different future time points and the corresponding confidence levels.

The vehicle location model may be trained based on a plurality of training samples with labels. In some embodiments, the training samples include a sample historical vehicle location, a sample real-time vehicle location, a sample historical speed, and a sample real-time speed, and the labels include a sample future vehicle location and a sample confidence level.

In some embodiments, the training samples with labels may be obtained based on historical data. For example, the system model may obtain a plurality of sets of historical travel logs; identify all vehicle locations and speeds within a first time range (T1, T2) in the historical travel logs as sample historical vehicle locations and sample historical speeds; identify the vehicle location and speed at the time point T2 as the sample real-time vehicle location and sample real-time speed; and identify all vehicle locations and speeds within a second time range (T2, T3) as sample future vehicle locations and sample confidence levels. The time point T1 is earlier than the time point T2, and the time point T2 is earlier than the time point T3.

In some embodiments, the system model may train the vehicle location model based on the training samples and the labels via a plurality of manners. For example, the system model may perform a plurality of iterations At least one of iterations includes: selecting one or more training samples from the sample data; obtaining one or more model prediction outputs corresponding to the one or more training samples by inputting the one or more training samples into the vehicle location model; calculating a value of a predefined loss function by substituting the model prediction outputs corresponding to the one or more training samples and the training labels of the one or more training samples into a formula for the predefined loss function; and inversely updating model parameters in the vehicle location model based on the value of the loss function, wherein this operation may be performed using various methods. For example, the updating may be performed based on a gradient descent method. When an iteration terminal condition is satisfied, the iteration is terminated, and a trained vehicle location model is obtained. The iteration terminal condition may be that the loss function converges, the count of iterations reaches a threshold, etc.

In some embodiments, when a plurality of future vehicle locations exists at one future time point, the system model may determine a future vehicle location for that future time point based on a confidence level. For example, the system model determines the future vehicle location with a confidence level greater than a preset confidence threshold as the currently desired future vehicle location. As another example, the system model determines the future vehicle location with the highest confidence level as the currently desired future vehicle location.

In some embodiments of the present disclosure, by using the vehicle location model to predict the future vehicle location, the future vehicle location can be predicted quickly and accurately, which can help the system model plan caching and migration strategies in advance, reduce service latency, and improve the user experience.

In some embodiments, the system model may also determine an estimated service type for a vehicle based on real-time in-vehicle data and historical in-vehicle data from the OBU; and determine a future service frequency based on estimated service types for a plurality of vehicles. More descriptions of the OBU may be found in the related description above.

The in-vehicle data may reflect relevant features of the vehicle request service. For example, the in-vehicle data includes the service type, the service location, and the service time.

In some embodiments, the system model may construct a first preset table based on the historical in-vehicle data, and determine the estimated service type by querying the first preset table. For example, the first preset table includes a plurality of first samples and corresponding first labels. The system model identifies a historical service type, a historical service location, and a historical service time at a first point time as samples, and identifies a historical service type at a second point time as a label. The second time point is later than the first time point.

When the system model consults the first preset table, it may select the first sample with the highest similarity to the real-time in-vehicle data through similarity matching and identify the historical service type of the first label as the estimated service type.

The vehicle request service includes: an in-vehicle service type, a service location, and a service time.

In some embodiments, the system model estimates estimated service types for different vehicles in a future time period by consulting the first preset table.

In some embodiments, the system model determines the future service frequency based on the estimated service types for a plurality of vehicles. The future service frequency refers to an estimated service frequency at the future time point.

Taking the determination of the future service frequency of the service k as an example, in some embodiments, the system model may count an estimated total request count for the service k for all vehicles in the future time period based on the described estimated service types for the plurality of vehicles, and an estimated total request count for all vehicles for all services. A percentage of the estimated total request count for the service k out of the estimated total request count for all services is determined as the future service frequency for the service k.

In some embodiments, the system model may determine the future service frequency by referring to the manner in formula (11).

In some embodiments of the present disclosure, by estimating the future service frequency, accurate scheduling of the IoV resources and advance service caching can be realized while ensuring the vehicle service, so that realizes the purpose of cost reduction and efficiency.

In some embodiments, the system model determines an estimated count of RSU migrations in the vehicle request service based on the future vehicle location, and determines an estimated total migration cost for the vehicle.

The estimated count of RSU migrations is a count of RSU migrations at the future time point obtained by estimation, and the estimated total migration cost is a total migration cost at the future time point obtained by estimation. More descriptions of the count of RSU migrations and the total migration cost may be found in FIG. 2 and related descriptions thereof.

The steps for determining the estimated count of RSU migrations are similar to those for determining the count of RSU migrations. The system model may obtain an estimated action trajectory of the UV based on the future vehicle location, determine whether the vehicle crosses a boundary of the RSU coverage at a future time point based on the estimated action trajectory and the RSU coverage, determine an estimated count of RSU migrations in the vehicle request service based on whether the vehicle crosses the boundary of the RSU coverage at the future time point, i.e., an estimated RSU migration decision and an estimated task migration process, and determine an estimated BS migration decision based on the estimated RSU migration decision and the estimated task migration process. More descriptions of this section may be found in FIG. 2 and related descriptions thereof.

The steps for determining the estimated total migration cost are similar to those for determining the count of total migration cost. The system model may determines an time interval between the current time point and the future time point as a future time slot, replace the time slot t with the future time slot, replace the RSU migration decision with the estimated RSU migration decision, replace the BS migration decision mig_{v,n}(t) with the estimated BS migration decision, and determine the estimated total migration cost based on formula (19) to formula (20) in FIG. 2.

In some embodiments, the system model determines an estimated latency and an estimated energy consumption of the vehicle in the vehicle request service based on the future service frequency, and determines an estimated caching cost during the process of requesting the service.

The steps for determining the estimated latency and the estimated energy consumption are similar to the steps for determining the latency and energy consumption. The system model may determine an estimated caching decision based on the future service frequency and a preset frequency threshold, determine a time interval between the current time point and the future time point as a future time slot, replace the time slot t with the future time slot, replace the caching decision x_{n,k}(t) with the estimated caching decision, and determine the estimated latency and estimated energy consumption based on formula (13) to formula (16) in FIG. 2.

The steps for determining the estimated caching cost are similar to the steps for determining the caching cost. The system model determines the estimated total latency and estimated total energy consumption of all vehicles at the future time point based on the estimated latency and estimated energy consumption, determines a time interval between the current time point and the future time point as a future time slot, replaces the time slot t with the future time slot, replace, replaces the total latency T(t) and the total energy consumption E(t) with the estimated total latency and estimated total energy consumption, and determines the estimated caching cost based on formula (17) in FIG. 2.

In some embodiments, the system model determines an optimal caching decision and an optimal migration decision based on the total migration cost, the caching cost, the estimated total migration cost, and the estimated caching cost.

In some embodiments, the system model may establish a joint optimization problem for service caching and task migration based on the total migration cost, the caching cost, the estimated total migration cost, and the estimated caching cost, and solve the joint optimization problem for service caching and task migration using a multi-intelligence body reinforcement learning method (MADDPG algorithm) to obtain the optimal caching decision and the optimal migration decision. More descriptions of the Markov decision process may be found in FIG. 2 and related descriptions thereof. More descriptions of the multi-intelligence body reinforcement learning method (MADDPG algorithm) may be found in FIG. 3 and related descriptions thereof.

In some embodiments of the present disclosure, by predicting vehicle trajectories, proactive pre-migration and pre-caching of services are completed before vehicles enter the coverage of new RSUs. This enables vehicles to obtain a seamless, continuous, and low-latency service experience, significantly enhancing user experience while optimizing network resource utilization, reducing operator costs, and achieving a balance between caching costs and migration costs.

The embodiments described above provide further detailed explanations of the objectives, technical solutions, and advantages of this application. It should be understood that these embodiments are merely preferred implementations of this application and are not intended to limit its scope. Any modifications, equivalent replacements, or improvements made within the spirit and principles of this application shall fall within the protection scope of this application.

What is claimed is:

1. A method for service caching and task migration based on Internet of Vehicles (IoV), comprising:
S1, establishing a system model based on the Internet of Vehicles, and constructing a service caching model and a task migration model based on the system model, the system model including a device layer, an edge layer, and a cloud layer, wherein
the device layer includes a vehicle user (UV) and a roadside unit (RSU),
the edge layer includes a base station (BS) and a mobile edge computing (MEC) server of the BS, the BS corresponding to a plurality of RSUs,
the cloud layer includes a supplier,
the RSU is configured to receive a service request from the UV and send the service request to the BS corresponding to the edge layer, and
the MEC server of the BS is configured to cache a service provided by the supplier of the cloud layer and provide the service to the UV via the corresponding RSU;
S2, constructing a joint optimization problem for service caching and task migration based on the service caching model and the task migration model, wherein constructing the task migration model includes:
representing a maximum data amount transmittable to a vehicle v within a coverage of an RSU m as
$${D}_{m , v}^{max}$$
wherein sₖ denotes a size of a vehicle request service k,
$${s}_{k} > {D}_{m , v}^{max}$$
indicates that a task migration occurs, and
$${s}_{k} \leq {D}_{m , v}^{max}$$
indicates that the task migration does not occur,
representing an RSU migration decision as W_{v,k}(t)∈{0,1,2,3 . . . }, which denotes a count of RSU migrations during a process of the vehicle v requesting the vehicle request service k,
representing a BS migration decision as mig_{v,n}(t)∈{0,1}, wherein mig_{v,n}(t)=1 indicates that the vehicle v drives away from a coverage of a current BS, and mig_{v,n}(t)=0 indicates that the vehicle v does not drive away from the coverage of the current BS, and
calculating a total migration cost
$${C}_{all}^{mig} ( t )$$
for the vehicle request service k based on the RSU migration decision and the BS migration decision, wherein K denotes a count of vehicle request services, V denotes a count of vehicles, N denotes a count of all MEC servers, and sₖ denotes a size of the vehicle request service k;
S3, abstracting the joint optimization problem into a Markov decision process; and
S4, determining an optimal caching decision and an optimal migration decision by solving the joint optimization problem of service caching and task migration using a multi-intelligence body reinforcement learning method based on the Markov decision process.

2. The method according to claim 1, further comprising:
generating a caching instruction based on the optimal caching decision, the caching instruction including a target MEC server, a target caching time, and a target service;
sending the caching instruction to the target MEC server, and controlling the target MEC server to cache, at the target caching time, the target service from a remote server, the target service including road emergency data, traffic safety information, broadcast and entertainment information;
generating at least one of an RSU migration instruction and a BS migration instruction based on the optimal migration decision;
sending the at least one of the RSU migration instruction and the BS migration instruction to a corresponding in-vehicle unit OBU;
controlling the in-vehicle unit OBU to send a connection request to at least one of a to-be-connected RSU and a to-be-connected BS; and
controlling the in-vehicle unit OBU to establish a communication connection with at least one of the to-be-connected RSU and the to-be-connected BS through an assigned IP address and a wireless channel.

3. The method according to claim 1, wherein constructing the service caching model includes:
calculating a service frequency φₖ(t);
obtaining a caching decision x_{n,k}(t) for the vehicle request service k based on the service frequency φₖ(t), wherein x_{n,k}(t)=1 indicates that an MEC server n caches the vehicle request service k from the supplier during a time slot t, and x_{n,k}(t)=0 indicates that the MEC server n does not cache the vehicle request service k during the time slot t; and
calculating a caching cost
$${C}_{all}^{cost} ( t )$$
of the vehicle request service k based on the caching decision x_{n,k}(t) for the vehicle request service k.

4. The method according to claim 3, wherein calculating the service frequency φₖ(t) includes:
obtaining a binary variable e_{v,k}(t), which indicates whether the vehicle v requests the vehicle request service k during the time slot t;
calculating a request count for the vehicle request service k and a total request count for all services based on e_{v,k}(t); and
calculating the service frequency φₖ(t) of the vehicle request service k based on the request count for the vehicle request service k and the total request count for the all services.

5. The method according to claim 3, wherein the calculating a caching cost
$${C}_{all}^{cost} ( t )$$
of the vehicle request service k based on the caching decision x_{n,k}(t) for the vehicle request service k includes:
calculating a latency t_{v,k}(t) and an energy consumption E_{v,k}(t) generated by each vehicle v based on the caching decision x_{n,k}(t) for the vehicle request service k;
calculating a total latency T(t) and a total energy consumption E(t) generated by all vehicles based on the latency t_{v,k}(t) and the energy consumption E_{v,k}(t); and
determining the caching cost
$${C}_{all}^{cost} ( t )$$
of the vehicle request service k by weighting and combining the total latency T(t) and the total energy consumption E(t).

6. The method according to claim 1, wherein the calculating a total migration cost
$${C}_{all}^{mig} ( t )$$
for the vehicle request service k based on the RSU migration decision and the BS migration decision includes:
obtaining a unit migration cost H₁ for migrating the vehicle request service k to RSUs within the coverage of the current BS and a unit migration cost H₂ for migrating the vehicle request service k to RSUs outside the coverage of the current BS;
calculating a migration cost
$${C}_{v , k}^{mig} ( t )$$
for the vehicle request service k of the vehicle v based on the unit migration cost H₁, the unit migration cost H₂, the size sₖ of the vehicle request service k, the RSU migration decision, and the BS migration decision; and
calculating the total migration cost
$${C}_{all}^{mig} ( t )$$
for the vehicle request service k based on the migration cost
$${C}_{v , k}^{mig} ( t ) .$$

7. The method according to claim 6, wherein the calculating a migration cost
$${C}_{v , k}^{mig} ( t )$$
for the vehicle request service k of the vehicle v includes:
$${C}_{v , k}^{mig} ( t ) = {W}_{v , k} ( t ) {H}_{1} {s}_{k} + {mig}_{v , n} ( t ) {H}_{2} {s}_{k} , \qquad ( 1 )$$
where W_{v,k}(t) denotes the RSU migration decision, which indicates a count of RSU migrations during the process of the vehicle v requesting the vehicle request service k during the time slot t, and mig_{v,n}(t) denotes the BS migration decision, which indicates a binary variable indicating whether the vehicle v drives away from the current BS during the time slot t.

8. The method according to claim 1, wherein the joint optimization problem for service caching and task migration is expressed as:
$$max - ( {C}_{all}^{cost} ( t ) + {C}_{all}^{mig} ( t ) ) , \qquad ( 2 )$$
$$s . t . {\sum }_{k = 1}^{K} {e}_{v , k} ( t ) \leq 1 v ∈ \{ 1 , 2 , ... ... , V \} , \qquad ( 3 )$$
$${\sum }_{k = 1}^{K} {x}_{n , k} ( t ) {s}_{k} \leq {S}_{max} n ∈ \{ 1 , 2 , 3 , ... ... , N \} , \qquad ( 4 )$$
$${x}_{n , k} ( t ) ∈ \{ 0 , 1 \} n ∈ \{ 1 , 2 , 3 , ... ... , N \} , k ∈ \{ 1 , 2 , 3 , ... ... , K \} , \qquad ( 5 )$$
$${W}_{v , k} ( t ) \geq 0 v ∈ \{ 1 , 2 , ... ... , V \} , k ∈ \{ 1 , 2 , 3 , ... ... , K \} , \qquad ( 6 )$$
$${mig}_{v , n} ( t ) ∈ \{ 0 , 1 \} v ∈ \{ 1 , 2 , ... ... , V \} , n ∈ \{ 1 , 2 , 3 , ... ... , N \} , \qquad ( 7 )$$
$$0 < {p}_{v , m} ( t ) \leq {p}_{max} v ∈ \{ 1 , 2 , ... ... , V \} , m ∈ \{ 1 , 2 , ... ... , M \} , \qquad ( 8 )$$
$$0 < {p}_{n} ( t ) \leq {p}_{max} n ∈ \{ 1 , 2 , 3 , …… , N \} , \qquad ( 9 )$$
where
$${C}_{all}^{cost} ( t )$$
denotes the caching cost of the vehicle request service k during a time slot t,
$${C}_{all}^{mig} ( t )$$
denotes the total migration cost for the vehicle request service k during the time slot t, e_{v,k}(t) denotes a binary variable indicating whether the vehicle v performs the vehicle request service k during the time slot t, K denotes the count of the vehicle request services, V denotes the count of the vehicles, N denotes the count of the MEC servers, M denotes a count of RSUs, x_{n,k}(t) denotes a caching decision indicating whether an MEC server n caches the vehicle request service k during the time slot t, Sₖ denotes the size of the vehicle request service k, Sₘₐₓ denotes a storage capacity limit of the MEC server n, W_{v,k}(t) denotes the RSU migration decision indicating the count of the RSU migrations during the process of the vehicle v requesting the vehicle request service k during the time slot t, mig_{v,n}(t) denotes the BS migration decision indicating the binary variable indicating whether the vehicle v drives away from the current BS during the time slot t, p_{v,m}(t) denotes a transmission power between the vehicle v and the RSU m during the time slot t, pₙ(t) denotes a transmission power between the supplier and the current BS, and pₘₐₓ denotes a maximum transmission power.

9. The method according to claim 8, wherein
a state space of the Markov decision process is O(t)={P(t),Θ(t),D},
an action space of the Markov decision process is A(t)={X(t),N(t),M(t)}, and
a reward function of the Markov decision process is
$$R ( t ) = - ( {C}_{all}^{cost} ( t ) + {C}_{all}^{mig} ( t ) ) ,$$
where P(t) denotes a set of locations of the vehicles during the time slot t, Θ(t) denotes a set of service frequencies φₖ(t) during the time slot t, D denotes a set of maximum data amounts
$${D}_{m , v}^{max}$$
transmittable to all vehicles within a coverage of the RSU, X(t) denotes a set of caching decisions x_{n,k}(t), W(t) denotes a set of RSU migration decisions W_{v,k}(t), and M(t) denotes a set of BS migration decisions mig_{v,n}(t).

10. The method according to claim 9, wherein
the state space further includes a future vehicle location and a future service frequency of the vehicle v at a future time point, a time interval between the future time point and a current time point being less than the time slot t;
determining the future vehicle location based on a real-time vehicle location by predictive processing;
determining an estimated count of RSU migrations in the vehicle request service k based on the future vehicle location, and determining an estimated total migration cost for the vehicle v;
determining an estimated latency and an estimated energy consumption of the vehicle v in the vehicle request service k based on the future service frequency, and determining an estimated caching cost during the process of the vehicle request service k; and
determining the optimal caching decision and the optimal migration decision based on the total migration cost, the caching cost, the estimated total migration cost, and the estimated caching cost.

11. The method according to claim 10, wherein
determining the future vehicle location using a vehicle location model, the vehicle location model being a machine learning model.

12. The method according to claim 9, wherein the determining the future service frequency includes:
determining an estimated service type for the vehicle v based on in-vehicle data from the in-vehicle unit OBU, the in-vehicle data including real-time in-vehicle data and historical in-vehicle data, the in-vehicle data including at least a service type, a service location, and a service time; and
determining the future service frequency based on estimated service types of the vehicles.
